(19) United States
(12) Patent Application Publication
(10) Pub. No.: US 2023/0385821 A1
(43) Pub. Date: Nov. 30, 2023

(54) SYSTEM AND METHOD FOR A CRYPTO CURRENCY SYSTEM USING POLLUTION REDUCTION ACTIVITIES

(71) Applicant: EFFICIENCY ENERGY LLC, Raleigh, NC (US)

(72) Inventors: Justin SULLIVAN, Chestnut Hill, MA (US); Eliot ASSIMAKOPOULOS, Pittsburgh, PA (US); Byrne HUDDLESTON, Raleigh, NC (US); William VOLKER, Raleigh, NC (US)

(73) Assignee: EFFICIENCY ENERGY LLC, Raleigh, NC (US)

(21) Appl. No.: 18/324,666

(22) Filed: May 26, 2023

Related U.S. Application Data
(60) Provisional application No. 63/346,768, filed on May 27, 2022.

(51) Int. Cl. G06Q 20/38; G06Q 50/26; G06Q 10/30; H02J 3/38

(52) U.S. Cl. CPC G06Q 20/389; G06Q 50/26; H02J 2300/24; H02J 3/381; G06Q 10/30

(57) ABSTRACT

The disclosed technology includes methods of acquiring and trading a cryptocurrency using a pollution reduction system. The system includes a pollution reduction system, a sensor, a computing device, a communications network, and a cryptocurrency system. The method includes detecting a reduction of greenhouse gases (GHGs) produced by the pollution reduction system or an amount of plastics recycled by the plastics emissions system using the sensor responsive to operating the system. The method further includes determining carbon credits earned for the reduction of GHGs produced by the pollution reduction system. or determining plastic credits for the amount of plastics recovered or recycled using a plastics emissions calculation methodology. The method also includes awarding an amount of cryptocurrency corresponding to the reduction of GHGs produced by the pollution reduction system or the amount of plastics recycled by the plastics emissions pollution reduction system.

### CROSS REFERENCE TO RELATED APPLICATION

This application claims priority to and the benefit of U.S. Provisional Patent Application No. 63/346,768, filed May 27, 2022, and entitled SYSTEM AND METHOD FOR A CRYPTO CURRENCY SYSTEM USING GREENHOUSE GAS EMISSION ACTIVITIES, the disclosure of which is incorporated herein by reference in its entirety.

### TECHNICAL FIELD

The present disclosure relates generally to crypto currencies, and more particularly relates to systems and methods for a crypto currency system using pollution reduction activities.

### BACKGROUND

A digital currency is a medium of exchange transacted through electronic means. One category of digital currencies is blockchain-based crypto currencies, whereby cryptography is utilized to create new “tokens” and validate transactions. Bitcoin is a well-known example of a blockchain-based crypto currency. Blockchain-based cryptocurrencies typically validate the creation and transaction of the crypto currency by utilizing what is typically known as a “proof of work” methodology. This validation methodology involves computationally solving complex problems that are easily verifiable. These computational processes, sometimes called “mining,” require a significant amount of energy to perform given the large number of computations performed to mine the crypto currency. For example, each Bitcoin transaction consumes 1,173 kilowatt hours of electricity. This amount of electricity is the volume of energy that can power a typical American home for six weeks.

Another methodology utilized to validate blockchain transactions is called “proof of stake.” The proof of stake consensus adopts a different mining model. In this model, miners are referred to as stakers or validators and are not required to perform any cryptographic task. Staking is like voting, as participants stake a certain amount of crypto currency behind a block they wish to add to the blockchain. As such, this methodology does not require the same computational power as proof of work and is less energy intensive.

Pollution reduction activities, including greenhouse gas (GHG) reduction and recycling, is part of regulatory schemes throughout the world to mitigate climate change. Some of these regulatory schemes are compliance schemes that require compliance as a matter of law and some of these regulatory schemes are volunteer pledge schemes that are dependent on the participants within the scheme self-complying with the regulatory scheme. Most of the regulatory schemes include a cap and trade system that enables participants to trade carbon credits. Typically, these carbon credits are generated by completing pollution reduction activities including reducing GHG emissions and/or plastic recycling. Carbon credits may be used to offset a carbon or GHG emitting activity. Similarly, plastic credits are transferable certificates representing a collection of weight of plastic waste that is removed from the environment and can be recycled into new products and packaging. As such, a market has been created where such credits may be traded or sold. In at least some jurisdictions, before a credit can be traded or sold, the credit must be verified or certified as a compliance credit by a certification organization. The certification process may be an analog, time consuming process that hinders the credit market. There is a need for a digital, quick proof-of work certification of credits that is used for a blockchain based exchange system for credits.

### SUMMARY

The disclosed technology includes methods of acquiring and trading a cryptocurrency using a system. The systems include a pollution reduction system, a sensor, a computing device, a communications network, and a cryptocurrency system.

The methods include operating a pollution (e.g., carbon or plastic) reduction system. For example, the methods include detecting a reduction of greenhouse gases (GHGs) produced by a pollution reduction system or an amount of plastics recycled by the recycling system using the sensor responsive to operating the plastics recycling system. The method further includes determining carbon credits earned for the reduction of GHGs produced by the reduction system or the amount of plastics recycled by the recycling system using a plastic emissions calculation methodology. The method also includes awarding an amount of cryptocurrency corresponding to the reduction of emissions (e.g., GHGs) produced by the pollution reduction system or the amount of plastics recycled by the recycling system.

In some embodiments, a system for reducing emissions (e.g., GHGs) includes a reduction system installed within a facility, a sensor, a computing device, and a cryptocurrency system. The sensor is installed within the facility and may be configured to detect a reduction of emissions produced by the facility. The computing device may be configured to determine credits earned for the reduction of emissions produced by the facility using a reduction (e.g., carbon or plastics) calculation methodology. The cryptocurrency system may be configured to awarding an amount of cryptocurrency corresponding to the reduction of emissions produced by the facility.

In some embodiments, a system for recycling plastics includes a plastics recycling system, a sensor, a computing device, and a cryptocurrency system. The sensor is installed within the plastics recycling system and may be configured to detect an amount of plastic recycled by the plastics recycling system. The computing device may be configured to determine credits earned for the amount of plastic recycled by the plastics recycling system using a plastics recycling calculation methodology. The cryptocurrency system may be configured to awarding an amount of cryptocurrency corresponding to the amount of plastic recycled by the plastics recycling system.

In some embodiments, a method includes acquiring and trading a cryptocurrency using a system. The system includes a plastics recycling system, a sensor, a computing device, a communications network, and a cryptocurrency system. The method includes operating the plastics recycling system. The method also includes detecting an amount of plastics recycled by the plastics recycling system. The method further includes determining plastic credits earned for the recycling of plastics by the plastics recycling system using a plastic recycling calculation methodology. The method also includes awarding an amount of cryptocurrency corresponding to the recycling of plastics by the plastics recycling system.

In some embodiments, a method includes acquiring and trading a cryptocurrency using a system. The system includes a GHG reduction system, a sensor, a computing device, a communications network, and a cryptocurrency system. The method includes operating the GHG reduction system to reduce GHGs produced by a facility. The method also includes detecting a reduction of GHGs produced by the facility using the sensor. The method further includes determining carbon credits earned for the reduction of GHGs produced by the facility using a carbon reduction calculation methodology, wherein the carbon reduction calculation method calculates a baseline emissions of the facility using the following equation:

$$B {E}_{y} = \sum \frac{E {D}_{i y} \times E {F}_{i f y} \times 100 \times {IR}_{i y}^{y - 1}}{A F E {C}_{i y} \times {MPG}_{i y}}$$

where BEy is the baseline emissions in a year y, EDi,y is the electricity delivered by a project charging systems serving applicable fleet i in project year y, EFj,f,y is the emission factor for the fossil fuel f used by comparable fleet vehicles j in project year y, IRi is the technology improvement rate factor for the applicable fleet i, AFECi,y is the weighted average electricity consumption per 100 miles rating for EVs in applicable fleet i in projection year y, and MPGi,y is the weighted average miles per gallon rating for the fossil fuel vehicles comparable to each EV in the applicable fleet i in the project year y. The method also includes awarding an amount of cryptocurrency corresponding to the reduction of GHGs produced by the facility.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 illustrates an example system for generating carbon credits and trading or selling the carbon credits on a cryptocurrency system in accordance with aspects of the present disclosure.

FIG. 2 illustrates a diagram of the cryptocurrency system shown in FIG. 1 in accordance with aspects of the present disclosure.

FIG. 3 illustrates an example of a flow diagram of a method of acquiring and trading carbon credits in accordance with aspects of the present disclosure.

FIG. 4 illustrates an example of a flow diagram of another method of acquiring and trading plastic credits in accordance with aspects of the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Embodiments of the present disclosure include methods and systems for a system for generating credits (e.g., carbon credits or plastic credits) and trading or selling the credits on a cryptocurrency system. The system includes a pollution reduction system, a sensor, a computing device, and a cryptocurrency system. During operation, the pollution reduction system reduces pollution production from a baseline of pollution production or recycles material. The sensor automatically detects the reduction of pollution production or the amount of recycling and communicates the reduction of pollution production or the amount of recycling to the computing device which determines credits earned for the activity using a calculation methodology. The computer device communicates the credits earned to the cryptocurrency system and the cryptocurrency system awards the credits.

For example, embodiments of the present disclosure include methods and systems for a system for generating carbon credits and trading or selling the carbon credits on a cryptocurrency system. The system includes a GHG reduction system, a sensor, a computing device, and a cryptocurrency system. During operation, the GHG reduction system reduces GHG production from a baseline of GHG production. The sensor automatically detects the reduction of GHG production and communicates the reduction of GHG production to the computing device which determines carbon credits earned for the reduction of GHG production using a carbon reduction calculation methodology. The computer device communicates the carbon credits earned for the reduction of GHG production to the cryptocurrency system and the cryptocurrency system awards the carbon credits.

Embodiments of the present disclosure also include methods and systems for a system for generating plastic credits and trading or selling the plastic credits on a cryptocurrency system. The system includes a plastics recycling system, a sensor, a computing device, and a cryptocurrency system. During operation, the system operates the recycling system to recycle plastic waste and detect the amount of plastic recycled using a sensor. The computing device calculates the plastic credits earned for the amount of plastic recovered or recycled based on the weight of plastic (e.g., one kilogram, one metric ton) or a plastic emissions calculation methodology as a “Proof of Work”. The cryptocurrency system awards an amount of cryptocurrency corresponding to the plastic credits earned. In some embodiments, the system may be installed within a facility to recycle plastic waste and generate plastic credits. The disclosed technology allows for the incentivization and tracking of plastic waste recycling through the use of cryptocurrency.

In some embodiments, the plastics recycling system reduces plastics production/use from a baseline of plastics production/use. In some embodiments, the plastics recycling system increases plastics recycling from a baseline of recycling volume. The sensor automatically detects the reduction of plastics production/use and/or the increase of plastics recycling volume and communicates the reduction of plastics production/use and/or the increase of plastics recycling volume to the computing device which determines plastic credits earned using a plastics recycling calculation methodology. The computer device communicates the plastic credits earned to the cryptocurrency system and the cryptocurrency system awards the plastic credits.

In some embodiments, the system comprises a recycling system, a sensor, a computing device, a communication network, and a cryptocurrency system. The method involves operating the recycling system to recycle plastic waste and detecting the amount of plastic recycled using a sensor. The computing device calculates the plastic credits earned for the amount of plastic recycled based on the weight of recycled plastic or a plastic emissions calculation methodology as a “Proof of Work”. The cryptocurrency system awards an amount of cryptocurrency corresponding to the plastic credits earned. In some embodiments, the system may be installed within a facility to recycle plastic waste and generate plastic credits. The disclosed technology allows for the incentivization and tracking of plastic waste recycling through the use of cryptocurrency.

The system described herein enables an owner of a facility to install pollution reduction technology, monitor the pollution reduction technology, verify that pollution reduction has taken place, acquire credits, and be awarded cryptocurrency based on the credits in real time. As such, the system described herein reduces the burden of regulatory tasks imposed by regulatory schemes and increases the efficiency of pollution credit markets. Accordingly, the systems and methods described herein enables pollution credit markets to expand and enables owners of facilities to access the pollution credit markets.

These and other aspects of the disclosure are further described herein with reference to process diagrams, apparatus diagrams, system diagrams, and flowcharts that relate to systems and techniques that support identifying altered media data.

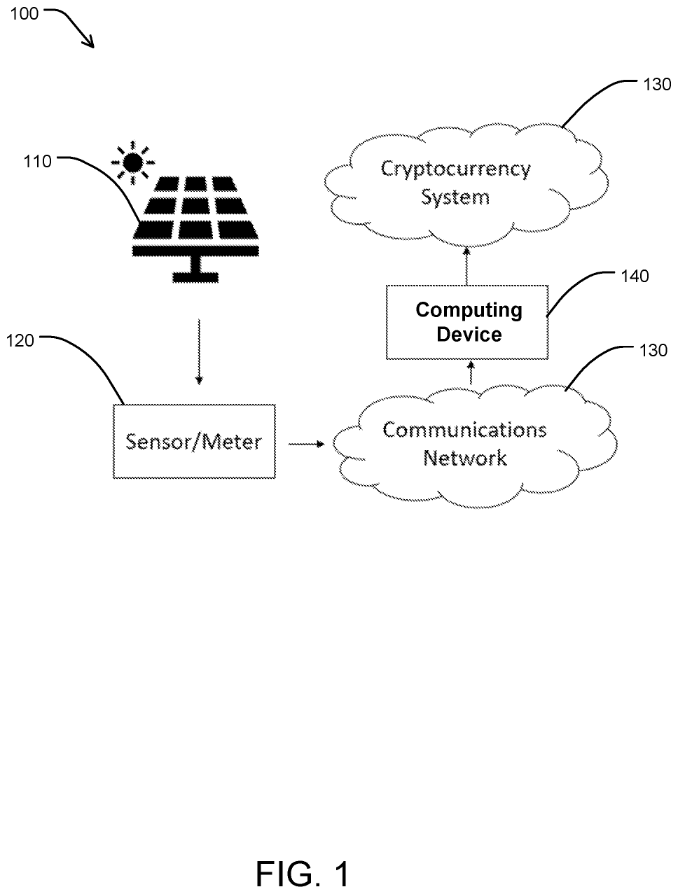

FIG. 1 illustrates an example system 100 for generating credits and trading or selling the credits on a cryptocurrency system. The example system in FIG. 1 is directed toward generating and trading or selling carbon credits on a cryptocurrency system. In other examples, the system may be directed toward generating and trading or selling plastic credits on a cryptocurrency system.

The example system 100 includes, but is not limited to, at least one of a pollution reduction system 110, a sensor 120, a communication network 130, a computing device 140, and a cryptocurrency system 150. During operation, the pollution reduction system 110 reduces pollution production or recycles reusable materials such as plastics or metals. The sensor 120 detects the reduction of pollution production or the amount recycled and communicates the reduction of pollution production or the amount recycled to the communications network 130.

The communication network 130 transmits the reduction of pollution production or the amount recycled to the computing device 140 which determines credits earned for the reduction of pollution production or the amount recycled using a calculation methodology. The computer device 140 communicates the credits earned for the reduction of pollution production or the amount recycled to the cryptocurrency system 150 and the cryptocurrency system 150 awards the credits as described herein.

The pollution reduction system 110 may include any system configured to reduce production of carbon or remove carbon from the environment. For example, the pollution reduction system 110 may include any system that produces electricity without carbon emissions or with reduced carbon emission, that increases recycling, that removes carbon from the environment, and/or reduces the production of carbon. The electricity generated by the system may be used to power homes, power electric cars, power businesses, power industrial facilities, and/or provide power to any energy consumer. The recycled carbon is used to create new products and the removed carbon may be stored. Thus, the pollution reduction system 110 reduces carbon emissions that are produced for productive purposes.

For example, the pollution reduction system 110 may include any system configured to reduce production of GHGs or remove GHGs from the atmosphere. In the illustrated embodiment, the pollution reduction system 110 includes a solar array that generates electricity from sunlight. The electricity generated by the solar array is used to power homes, power electric cars, power businesses, power industrial facilities, and/or provide power to any energy consumer. The amount of power provided by the solar array reduces the amount of energy that is required to be generated by GHG producing energy sources, such as, but not limited to, combustion of natural gas, combustion of oil, combustion of coal, and/or combustion of other fossil fuels. Thus, the solar array reduces GHGs that are produced for productive purposes.

In another embodiment, pollution reduction system 110 may include any system configured to recycle plastic waster, detect the amount of plastic recycled using a sensor, and calculate the plastics credits earned with a computing device based on the weight of recycled plastics or a plastic emissions calculation methodology as a “Proof of Work”. The cryptocurrency system awards an amount of cryptocurrency corresponding to the plastic credits earned. In the illustrated embodiment, the pollution reduction system 110 may include a plastics recycling facility that is configured to receive recovered plastic waste to be recycled, measured, and then into usable products. The usable products can include plastic products including bags, bottles, containers, and/or any other plastic product. The amount of usable plastic products produced by the plastics recycling facility reduces the amount of plastic products that are required to be generated by carbon producing facilities. Thus, the plastics recycling facility reduces plastic, in doing so, also can reduce carbon produced for productive purposes. In alternative embodiments, the recycling facility may include any facility configured to recycle any type of material including metals (steel, iron, aluminum, etc.), paper, glass, wood, cardboard, and/or other materials.

In alternative embodiments, the pollution reduction system 110 may include any system that is configured to reduce GHGs or carbon in general. For example, the pollution reduction system 110 may include wind turbines configured to produce electricity from the wind. Like the solar array discussed above, the wind turbine reduces the amount of energy that is required to be generated by GHG producing energy sources. The pollution reduction system 110 may include other technologies such as, but not limited to, geothermal, hydropower, wind, concentrating solar power, and biomass technologies. Additionally, the pollution reduction system 110 is not limited to conventional renewable energy technologies and may include other non-conventional technologies for industrial processes. For example, some industrial processes require a liquid to be heated to complete the process. The pollution reduction system 110 may include a system to heat the liquid with solar power rather than within a boiler that produces GHGs.

Additionally, the pollution reduction system 110 may also include systems that remove GHGs from the atmosphere. For example, the pollution reduction system 110 may include a direct air capture system that chemically scrubs carbon dioxide directly from the ambient air and stores it either underground or in long-lived products. Alternatively, the pollution reduction system 110 may include any other GHG removal technology including, without limitation, bio-energy with carbon capture and storage, carbon mineralization, PV Solar systems, Electric Vehicle charging, combined heat & power systems, lower carbon construction materials, nature-based GHG reduction systems, reduced-carbon fertilizer products, alternative fuel switching technology, and/or any other GHG removal technology.

For purposes of this disclosure the sensor 120 may include any sensor or meter that is configured to quantify the amount of GHGs the pollution reduction system 110 reduces or removes from the atmosphere or the amount of plastics the pollution reduction system 110 recycles. For example, in some embodiments, the sensor 120 may include a standard electricity meter that detects how much electricity is generated by the GHG reduction system 100. The electricity meter may detect how much electricity is generated by the solar array or the wind turbine. In alternative embodiments, the sensor 120 may be a sensor or meter that detect how much GHGs are removed from the atmosphere by the direct air capture system including, but not limited to, scanners or QR Code readers; energy management systems that we would interface with building EMS, ISO energy market data, utility energy data systems, and/or energy utilization data from supply chains; and/or any other sensor or meter. Additionally, the sensor 120 may also include a sensor configured to measure (e.g., weigh) the amount of plastics recycled by the pollution reduction system 110. For example, the sensor 110 may include a mass sensor configured to measure the mass of plastic recycled by the pollution reduction system 110. In alternative embodiments, the sensor 120 may include any type of sensor that is configured to calculate the amount of plastics or other material recycled by the pollution reduction system 110.

The communication network 130 may include any wired or wireless connection, the internet, or any other form of communication. Although one network 130 is identified in FIG. 1, the communication network 130 may include any number of different communication networks between any of the server, devices, resource and system shown in FIG. 1 and/or other servers, devices, resources and systems described herein. The communication network 130 may enable communication between various computing resources or devices, servers, and systems. Various implementations of communication network 130 may employ different types of networks, for example, but not limited to, computer networks, telecommunications networks (e.g., cellular), mobile wireless data networks, satellite data, and any combination of these and/or other networks.

The computing device 140 may include any device capable of processing and storing data/information and communicating over communication network 130. For example, the computing device 140 may include personal computers, servers, cell phones, tablets, laptops, smart devices (e.g., smart watches or smart televisions). The computing device may be any device that may include artificial intelligence (AI) and/or is configured to calculate carbon credit values, perform data processing, and/or perform analytics.

In the illustrated embodiment, the computing device 140 uses a calculation methodology to convert the reduction in GHGs or the amount of plastics recycled to a credit value suitable for the cryptocurrency system 150. For example, in some embodiments, the calculation methodology may include a GHG emission calculation methodology including a mathematical formula that converts the reduction in GHGs to the carbon credit value suitable for the cryptocurrency system 150. More specifically, in the illustrated embodiment, the computing device 140 may determine a predetermine a baseline amount of GHGs that a facility, home, business, and/or other electricity consumer produces. The computing device 140 then compares the amount of GHGs produced or electricity consumed when the facility, home, business, and/or other electricity consumer is operating with the pollution reduction system 110. The computing device 140 then calculates the carbon credits based on the reduction of GHGs. The computing device 140 then sends data corresponding to the carbon credits that are to be awarded to the cryptocurrency system 150.

For example, when the pollution reduction system 110 includes an electric vehicle charging station, the GHG emissions calculation methodology includes calculating baseline emission based on Eqn. 1 shown below where BE_{y} is the baseline emissions in a year y, ED_{i,y} is the electricity delivered by a project charging systems serving applicable fleet i in project year y, EF_{j,f,y} is the emission factor for the fossil fuel f used by comparable fleet vehicles j in project year y, IRᵢ is the technology improvement rate factor for the applicable fleet i, AFEC_{i,y} is the weighted average electricity consumption per 100 miles rating for EVs in applicable fleet i in projection year y, and MPG_{i,y} is the weighted average miles per gallon rating for the fossil fuel vehicles comparable to each EV in the applicable fleet i in the project year y:

$$B {E}_{y} = \sum \frac{E {D}_{i y} \times E {F}_{i f y} \times 100 \times {IR}_{i y}^{y - 1}}{A F E {C}_{i y} \times {MPG}_{i y}} \qquad Eqn . 1$$

The baseline emissions BE_{y} calculated in Eqn. 1 are then used to calculate the carbon credits that are to be awarded to the pollution reduction system 110 and the carbon credit value suitable for the cryptocurrency system 150. That is, the computing device 140 uses the GHG emissions calculation methodology to calculate baseline emissions BE_{y} using Eqn. 1, calculates a reduction in GHGs, and then converts the reduction in GHGs to a carbon credit value suitable for the cryptocurrency system 150.

In alternative embodiments, the calculation methodology includes a plastics recycling calculation methodology including calculating an amount of plastic recycled using a mathematical formula. The mathematical formula may determine the average amount of plastics recycled by the pollution reduction system 110 within a predetermined amount of time, and then converts the amount of plastic recycled to a plastic credit value suitable for the cryptocurrency system 150.

Additionally, the computing device 140 may verify whether the data collected by the sensor 120 satisfies the conditions for a credit for the cryptocurrency system 150. A plurality of certification or verification organizations may set standards for the conditions for a credit and the standards may be programed into the cryptocurrency system 150.

The cryptocurrency system 150 may include one or more computing devices including one or more processors and memory for processing information and storing information in one or more cryptocurrency data structures. The memory generally includes both volatile memory (e.g., RAM) and non-volatile memory (e.g., flash memory). An operating system resides in the memory and is executed by the processor(s). In some embodiments, the cryptocurrency system 150 may be a centralized cryptocurrency network including a server on a distributed decentralized computing system.

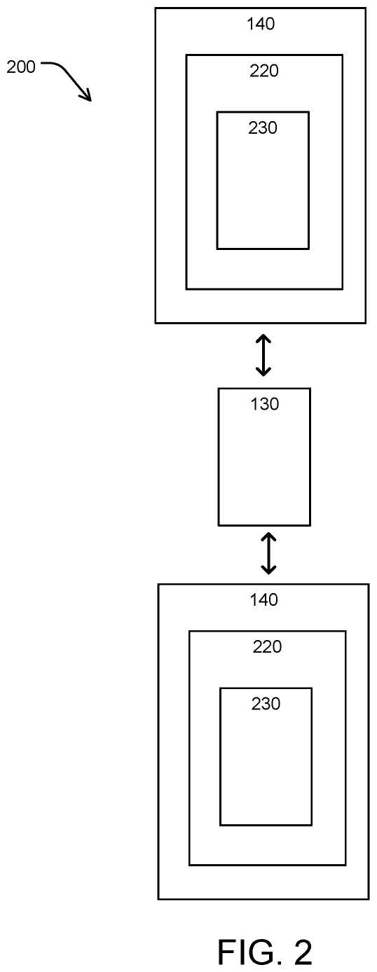

In some embodiments, the system 100 may include one or more modules or segments, such as an emissions reduction application (not shown), loaded into an operating system on the memory (e.g., memory 220) and/or storage and executed by the processor(s). For example, these modules may be located in the computing device 140. The emissions reduction application may include a calculation methodology implemented by a credit generation engine (not shown). Data such as emission measurements (e.g., a specified weight (e.g., one kilogram, one metric ton) of plastics recovered or recycled), hardware configurations, and hardware responses may be stored in the memory or storage and may be retrievable by the processor(s) for use by the credit generation engine. The storage may be local to the computing device 140 or may be remote and communicatively connected to the computing device 140 and may include another server. The storage may store resources that are requestable by other devices (not shown). The credit generation engine may execute on one or more processors to generate credits that should be awarded based on the measured emissions reduction. FIG. 2 illustrates a diagram of the cryptocurrency system 150. The cryptocurrency system 150 may be a decentralized network 200, such as a decentralized blockchain network, including one or more computing devices 140. Additionally, there may be no central authority controlling cryptocurrency network 200 and the data stored on the blockchain network 200 may be stored on a ledger 230 and may not be stored at a central location in its entirety. The blockchain network 200 may maintain one or more blockchains of continuously growing lists of data blocks, where each data block refers to previous blocks on its list. The requirement for each block to refer to all previous blocks in the blockchain, yields a chain of blocks that is hardened against tampering and revision, such that the information stored in the blockchain is immutable.

The computing devices 140 may include any device, computer, system or otherwise that has joined the blockchain network 200 and forms a node in the blockchain network 200. The computing devices 140 may include, for example, but not limited to, personal computers, servers, cell phones, tablets, laptops, smart devices (e.g., smart watches or smart televisions), or any other device capable of storing information and communicating over the communication network 130. In some embodiments, the computing devices 140 may be unaffiliated with or unknown to each other. Each computing device 140 may include memory 220 that stores a copy of at least a portion of the ledger 230 of the blockchain network 200. The computing devices 140 may also execute one or more programs to perform various functions associated with maintaining the blockchain network 200 including, for example, updating the ledger 230, generating new blocks, or any other similar function.

The ledger 230 may store any transactions performed over the blockchain network 200. Each computing device 140 stores a copy of at least a portion of the ledger 230 and the ledger 230 may be independently verified for accuracy at any time by comparing the stored copies of multiple the computing devices 140.

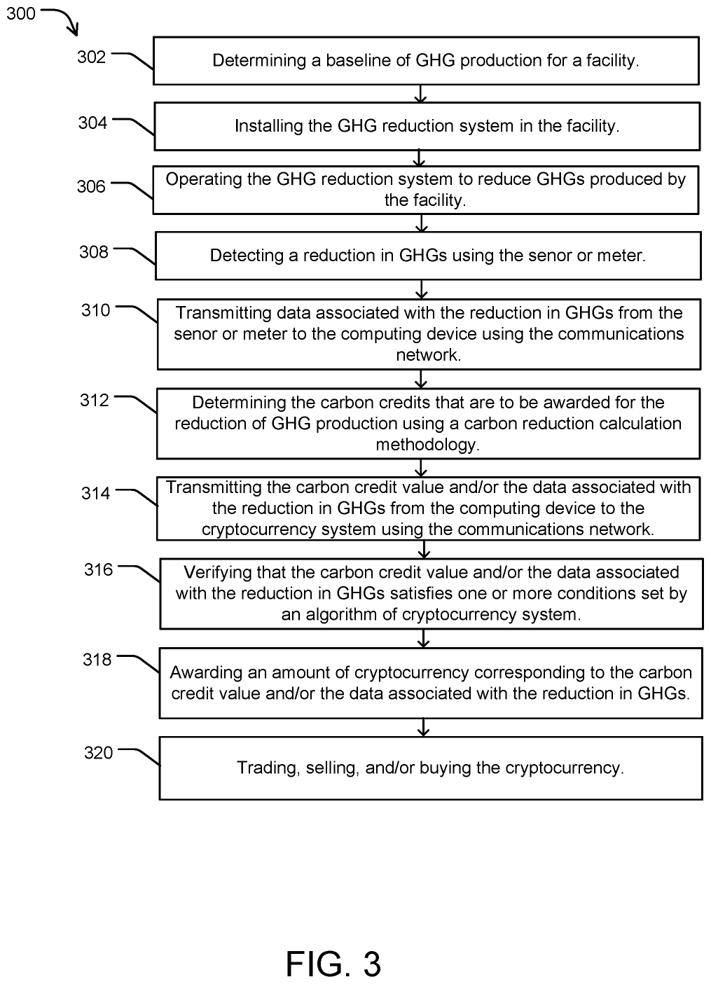

FIG. 3 shows a flow diagram of a method 300 of acquiring and trading carbon credits according to an exemplary embodiment of the present disclosure. The method 300 includes determining 302 a baseline of GHG production for a facility. The baseline of GHG production is the amount of GHGs the facility produces during normal operations. The baseline of GHG production may be determined by measuring the current operations of the facility and determining the amount of GHGs the facility produces during normal operations based on at least one operating parameter. For example, if the facility is a house, the baseline of GHG production may be determined by measuring the electricity consumed by the house and calculating the amount of GHGs the house produces based on the electricity consumed by the house at least partially based on the GHG emissions calculation methodology. In alternative embodiments, the baseline of GHG production of the facility may be determined using any method that enables the systems and methods described herein to operate as described herein.

The method 300 also includes installing 304 the pollution reduction system 110 in the facility. In some embodiments, the pollution reduction system 110 may be at least one solar panel that produces electricity for the facility to consume. For example, if the facility is a house, the at least one solar panel may be attached to the roof of the house. In alternative embodiments, the pollution reduction system 110 may be any technology that is installed in a facility in any manner that enables the systems and methods described herein to operate as described herein.

The method 300 further includes operating 306 the pollution reduction system 110 to reduce GHGs produced by the facility. In some embodiments, the pollution reduction system 110 may be at least one solar panel that produces electricity for the facility to consume. For example, if the facility is a house, the at least one solar panel may be attached to the roof of the house and the solar panel operates to reduce the amount of electricity from the grid or other GHG producing source of electricity. In alternative embodiments, the pollution reduction system 110 may be any technology that is operated in any manner that enables the systems and methods described herein to operate as described herein.

The method 300 also includes detecting 308 a reduction in GHGs using the sensor 120. In some embodiments, the sensor 120 may include any sensor or meter that is configured to quantify the amount of GHGs the pollution reduction system 110 reduces or removes from the atmosphere. For example, in some embodiments, the sensor 120 may include a standard electricity meter that detects how much electricity is generated by the GHG reduction system 100. If the facility is the house and the pollution reduction system 110 is the solar panel, the electricity meter determines how much electricity is produced by the solar panel and how much electricity is consumed by the house from the grid or other GHG producing source of electricity.

The method 300 further includes transmitting 310 data associated with the reduction in GHGs from the sensor 120 to the computing device 140 using the communications network 130. In some embodiments, the sensor 120 may include a standard electricity meter with wireless capabilities and the communications network 130 may include a wireless network. The data associated with the reduction in GHGs may be transmitted from the sensor 120 to the computing device 130 over the wireless network through the internet. In alternative embodiments, the communications network 130 maybe any type of communications network that transmits the data associated with the reduction in GHGs in any manner that enables the systems and methods described herein to operate as described herein.

The method 300 also includes determining 312 the carbon credits earned for the reduction of GHG production using a GHG emissions calculation methodology. In the illustrated embodiment, the computing device 140 uses a GHG emissions calculation methodology to convert the reduction in GHGs to a carbon credit value suitable for the cryptocurrency system 150. For example, in some embodiments, the GHG emissions calculation methodology may include a mathematical formula that converts the reduction in GHGs to the carbon credit value suitable for the cryptocurrency system 150. More specifically, in the illustrated embodiment, the computing device 140 establishes the baseline amount of GHGs that a facility, home, business, and/or other electricity consumer produces. The computing device 140 then compares the amount of GHGs produced or electricity consumed when the facility, home, business, and/or other electricity consumer is operating with the GHG reduction system 110 pollution reduction system 110. The computing device 140 then calculates the carbon credits based on the reduction of GHGs. In alternative embodiments, the GHG emissions calculation methodology may be any methodology that enables the systems and methods described herein to operate as described herein.

The method 300 further includes transmitting 314 the carbon credit value from the computing device 140 to the cryptocurrency system 150 using the communications network 130. As discussed above, the communications network 130 may include a wireless network and the carbon credit value may be transmitted from the computing device 140 to the cryptocurrency system 150 over the wireless network through the internet. In alternative embodiments, the communications network 130 maybe any type of communications network that transmits the carbon credit value in any manner that enables the systems and methods described herein to operate as described herein.

The method 300 also includes verifying 316 that the carbon credit value and/or the data associated with the reduction in GHGs satisfies one or more conditions set by an algorithm of cryptocurrency system 150. The conditions may be set by an accreditation board or organization that verifies that a carbon credit should be awarded. Additionally, machine learning algorithms may be used to determine if the carbon credit value and/or the data associated with the reduction in GHGs satisfies one or more conditions set by an algorithm of cryptocurrency system 150. If the carbon credit value and/or the data associated with the reduction in GHGs is within a target range, then the proof of work or proof of stake is considered solved, and a new block in the cryptocurrency system 150 is created.

The method 300 further includes awarding 318 an amount of cryptocurrency corresponding to the carbon credit value and/or the data associated with the reduction in GHGs. When the carbon credit value and/or the data associated with the reduction in GHGs transmitted from computing device 140 satisfies one or more conditions set by cryptocurrency system 150, cryptocurrency system 150 awards cryptocurrency to the owner of the pollution reduction system 110. For example, in the blockchain of the cryptocurrency system 150, if the cryptocurrency system 150 verifies 316 that the carbon credit value and/or the data associated with the reduction in GHGs satisfies one or more conditions set by an algorithm of cryptocurrency system 150, a new block is added to the blockchain. The new block may contain the number of cryptocurrency units assigned to the owner's address. The new blockchain with the additional added block is broadcasted around the cryptocurrency network 150.

The method 300 also includes trading, selling, and/or buying 320 the cryptocurrency. The owner of the cryptocurrency may trade, buy, and/or sell the awarded cryptocurrency with other owners of the cryptocurrency. The value of the cryptocurrency may fluctuate according to the market.

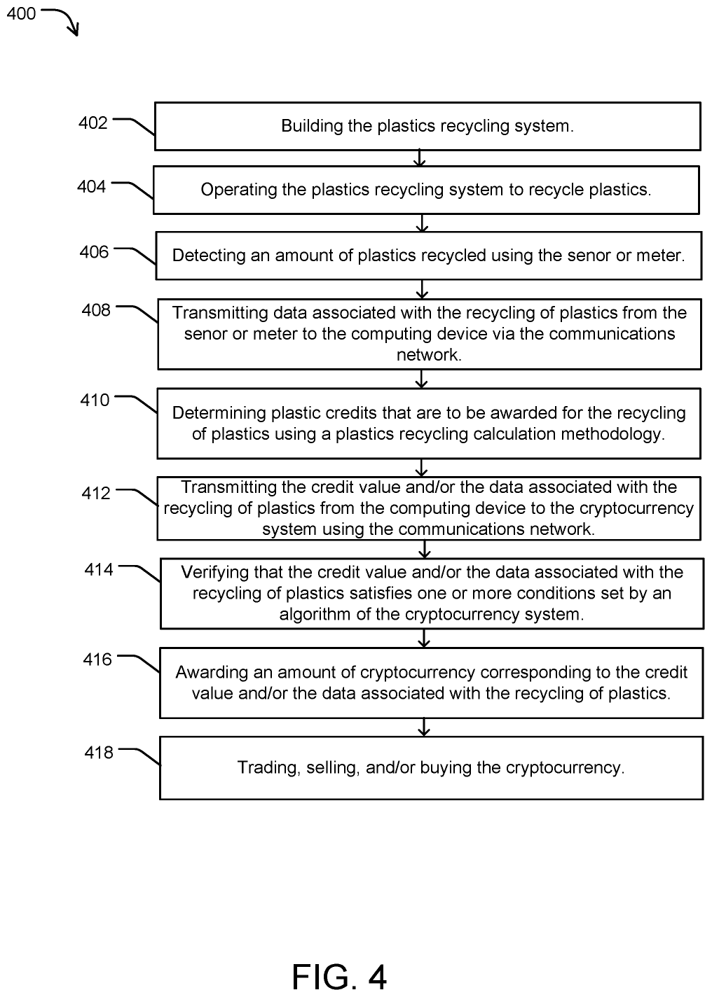

FIG. 4 shows a flow diagram of a method 400 of acquiring and trading plastic credits according to an exemplary embodiment of the present disclosure. The method 400 includes building 402 the pollution reduction system 110. In some embodiments, the pollution reduction system 110 may be at least one recycling facility. In alternative embodiments, the pollution reduction system 110 may be any technology that is installed in a facility in any manner that enables the systems and methods described herein to operate as described herein. For example, the pollution reduction system 110 may be a recycling station in a retail or office facility.

The method 400 further includes operating 404 the pollution reduction system 110 to recycle plastics. In some embodiments, the pollution reduction system 110 may be at least one recycling facility that recycles plastics. In alternative embodiments, the pollution reduction system 110 may be any technology that is operated in any manner that enables the systems and methods described herein to operate as described herein.

The method 400 also includes detecting 406 an amount of plastic recycled using the sensor 120. In some embodiments, the sensor 120 may include any sensor or meter that is configured to quantify the amount of plastics the pollution reduction system 110 reduces or recycles. For example, in some embodiments, the sensor 120 may include a standard mass meter that detects how much plastic is recycled by the system 100.

The method 400 further includes transmitting 408 data associated with the recycled plastic from the sensor 120 to the computing device 140 using the communications network 130. In some embodiments, the sensor 120 may include a standard mass meter with wireless capabilities and the communications network 130 may include a wireless network. The data associated with the recycling of plastics may be transmitted from the sensor 120 to the computing device 130 over the wireless network through the internet. In alternative embodiments, the communications network 130 maybe any type of communications network that transmits the data associated with the recycle of plastics in any manner that enables the systems and methods described herein to operate as described herein.

The method 400 also includes determining 410 the plastic credits earned for the recycling of plastics using a plastic recycling calculation methodology. In the illustrated embodiment, the computing device 140 uses a plastic recycling calculation methodology to convert the recycled plastics to a plastic credit value suitable for the cryptocurrency system 150. For example, in some embodiments, the plastic recycling calculation methodology may include a mathematical formula that converts the recycled plastics to the plastic credit value suitable for the cryptocurrency system 150. The computing device 140 calculates the plastic credits based on the amount or weight or recycled plastics. In alternative embodiments, the plastic recycling calculation methodology may be any methodology that enables the systems and methods described herein to operate as described herein.

The method 400 further includes transmitting 412 the plastic credit value from the computing device 140 to the cryptocurrency system 150 using the communications network 130. As discussed above, the communications network 130 may include a wireless network and the plastic credit value may be transmitted from the computing device 140 to the cryptocurrency system 150 over the wireless network through the internet. In alternative embodiments, the communications network 130 maybe any type of communications network that transmits the plastic credit value in any manner that enables the systems and methods described herein to operate as described herein.

The method 400 also includes verifying 414 that the plastic credit value and/or the data associated with the recycling of plastics satisfies one or more conditions set by an algorithm of cryptocurrency system 150. The conditions may be set by an accreditation board or organization that verifies that a plastic credit should be awarded. Additionally, machine learning algorithms may be used to determine if the plastic credit value and/or the data associated with the recycling of plastics satisfies one or more conditions set by an algorithm of cryptocurrency system 150. If the plastic credit value and/or the data associated with the recycling of plastics is within a target range, then the proof of work or proof of stake is considered solved, and a new block in the cryptocurrency system 150 is created.

The method 400 further includes awarding 416 an amount of cryptocurrency corresponding to the plastic credit value and/or the data associated with the recycling of plastics. When the plastic credit value and/or the data associated with the recycling of plastics transmitted from computing device 140 satisfies one or more conditions set by cryptocurrency system 150, cryptocurrency system 150 awards cryptocurrency to the owner of the pollution reduction system 110. For example, in the blockchain of the cryptocurrency system 150, if the cryptocurrency system 150 verifies 416 that the plastic credit value and/or the data associated with the recycling of plastics satisfies one or more conditions set by an algorithm of cryptocurrency system 150, a new block is added to the blockchain. The new block may contain the number of cryptocurrency units assigned to the owner's address. The new blockchain with the additional added block is broadcasted around the cryptocurrency network 150.

The method 400 also includes trading, selling, and/or buying 418 the cryptocurrency. The owner of the cryptocurrency may trade, buy, and/or sell the awarded cryptocurrency with other owners of the cryptocurrency. The value of the cryptocurrency may fluctuate according to the market.

Embodiments of the present disclosure include methods and systems for a system for generating credits (e.g., carbon credits or plastic credits) and trading or selling the credits on a cryptocurrency system. The system includes a pollution reduction system, a sensor, a computing device, and a cryptocurrency system. During operation, the pollution reduction system reduces pollution production from a baseline of pollution production or recycles material. The sensor automatically detects the reduction of pollution production or the amount of recycling and communicates the reduction of pollution production or the amount of recycling to the computing device which determines credits earned for the activity using a calculation methodology. The computer device communicates the credits earned to the cryptocurrency system and the cryptocurrency system awards the credits.

For example, embodiments of the present disclosure include methods and systems for a system for generating carbon credits and trading or selling the carbon credits on a cryptocurrency system. The system includes a GHG reduction system, a sensor, a computing device, and a cryptocurrency system. During operation, the GHG reduction system reduces GHG production from a baseline of GHG production. The sensor automatically detects the reduction of GHG production and communicates the reduction of GHG production to the computing device which determines carbon credits earned for the reduction of GHG production using a carbon reduction calculation methodology. The computer device communicates the carbon credits earned for the reduction of GHG production to the cryptocurrency system and the cryptocurrency system awards the carbon credits.

Embodiments of the present disclosure also include methods and systems for a system for generating plastic credits and trading or selling the plastic credits on a cryptocurrency system. The system includes a plastics recycling system, a sensor, a computing device, and a cryptocurrency system. During operation, the system operates the recycling system to recycle plastic waste and detect the amount of plastic recycled using a sensor. The computing device calculates the plastic credits earned for the amount of plastic recovered or recycled based on the weight of plastic (e.g., one kilogram, one metric ton) or a plastic emissions calculation methodology as a “Proof of Work”. The cryptocurrency system awards an amount of cryptocurrency corresponding to the plastic credits earned. In some embodiments, the system may be installed within a facility to recycle plastic waste and generate plastic credits. The disclosed technology allows for the incentivization and tracking of plastic waste recycling through the use of cryptocurrency.

In some embodiments, the plastics recycling system reduces plastics production/use from a baseline of plastics production/use. In some embodiments, the plastics recycling system increases plastics recycling from a baseline of recycling volume. The sensor automatically detects the reduction of plastics production/use and/or the increase of plastics recycling volume and communicates the reduction of plastics production/use and/or the increase of plastics recycling volume to the computing device which determines plastic credits earned using a plastics recycling calculation methodology. The computer device communicates the plastic credits earned to the cryptocurrency system and the cryptocurrency system awards the plastic credits.

The system described herein enables an owner of a facility to install pollution reduction technology, monitor the pollution reduction technology, verify that pollution reduction has taken place, acquire credits, and be awarded cryptocurrency based on the credits in real time. As such, the system described herein reduces the burden of regulatory tasks imposed by regulatory schemes and increases the efficiency of pollution credit markets. Accordingly, the systems and methods described herein enables pollution credit markets to expand and enables owners of facilities to access the pollution credit markets.

It should be noted that the methods described above describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method of acquiring and trading a cryptocurrency using a system, the system includes a pollution reduction system, a sensor, a computing device, a communications network, and a cryptocurrency system, the method comprises:
operating the pollution reduction system;
detecting a reduction of greenhouse gases (GHGs) produced by the pollution reduction system or an amount of plastics recycled by the pollution reduction system using the sensor responsive to operating the pollution reduction system;
determining credits earned for the reduction of GHGs produced by the pollution reduction system or the amount of plastics recycled by the pollution reduction system using a calculation methodology; and
awarding an amount of cryptocurrency corresponding to the reduction of GHGs produced by the pollution reduction system or the amount of plastics recycled by the pollution reduction system.

2. The method of claim 1, wherein detecting a reduction of GHGs produced by the pollution reduction system or an amount of plastics recycled by the pollution reduction system using the sensor responsive to operating the pollution reduction system comprises detecting an amount of plastics recycled by the pollution reduction system using the sensor responsive to operating the pollution reduction system.

3. The method of claim 1, wherein detecting a reduction of GHGs produced by the pollution reduction system or an increase of an amount of plastics recycled by the pollution reduction system using the sensor responsive to operating the pollution reduction system comprises detecting a reduction of GHGs produced by the pollution reduction system using the sensor responsive to operating the pollution reduction system.

4. The method of claim 3, further comprising determining a baseline of GHG production for the pollution reduction system.

5. The method of claim 4, wherein determining credits earned for the reduction of GHGs produced by the pollution reduction system or the amount of plastics recycled by the pollution reduction system using a calculation methodology comprises determining credits earned for the reduction of GHGs produced by the pollution reduction system based on the baseline of GHG production for the pollution reduction system, and wherein the credits comprise carbon credits.

6. The method of claim 1, further comprising installing the GHG reduction system in a facility.

7. The method of claim 1, further comprising transmitting data associated with the reduction of GHGs produced by the pollution reduction system from the sensor to the computing device using the communications network.

8. The method of claim 7, further comprising transmitting the credits value and/or the data associated with the reduction of GHGs produced by the pollution reduction system from the computing device to the cryptocurrency system using the communications network.

9. The method of claim 8, further comprising verifying that the credits value and/or the data associated with the reduction of GHGs produced by the pollution reduction system satisfies one or more conditions set by an algorithm of cryptocurrency system.

10. The method of claim 9, further comprising awarding an amount of cryptocurrency corresponding to the credit's value and/or the data associated with the reduction of GHGs produced by the facility.

11. The method of claim 10, further comprising trading, selling, and/or buying the cryptocurrency.

12. The method of claim 1, wherein the calculation methodology comprises a mathematical formula that converts data associated with the reduction of GHGs produced by the pollution reduction system to the credits.

13. The method of claim 1, wherein the system comprises a facility comprising a house, and wherein the method further comprises installing the GHG reduction system in the facility.

14. The method of claim 13, wherein the GHG reduction system comprises at least one solar panel attached to the house.

15. The method of claim 14, wherein the sensor comprises an electrical meter configured to detect electricity produced by the at least one solar panel.

16. A system for reducing GHGs comprising:
a GHG reduction system installed within a facility;
a sensor installed within the facility and configured to detect a reduction of GHGs produced by the facility;
a computing device configured to determine carbon credits earned for the reduction of GHGs produced by the facility using a carbon reduction calculation methodology; and
a cryptocurrency system configured to award an amount of cryptocurrency corresponding to the reduction of GHGs produced by the facility.

17. The system of claim 16, further comprising a communications network configured to transmit data associated with the reduction of GHGs produced by the facility from the sensor to the computing device.

18. A system for recycling plastics comprising:
a plastics recycling system;
a sensor installed within the plastics recycling system and configured to detect an amount of plastics recycled by the plastics recycling system;
a computing device configured to determine plastics credits earned for the amount of plastics recycled by the plastics recycling system using a plastics recycling calculation methodology; and
a cryptocurrency system configured to award an amount of cryptocurrency corresponding to the amount of plastics recycled by the plastics recycling system.

19. A method of acquiring and trading a cryptocurrency using a system, the system includes a plastics recycling system, a sensor, a computing device, a communications network, and a cryptocurrency system, the method comprises:
operating the plastics recycling system;
detecting an amount of plastics recycled by the plastics recycling system with a sensor;
determining plastic credits earned for the recycling of plastics by the plastics recycling system with the computing device using a plastic recycling calculation methodology; and
awarding an amount of cryptocurrency corresponding to the recycling of plastics by the plastics recycling system.

20. A method of acquiring and trading a cryptocurrency using a system, the system includes a greenhouse gas (GHG) reduction system, a sensor, a computing device, a communications network, and a cryptocurrency system, the method comprises:
operating the GHG reduction system to reduce GHGs produced by a facility;
detecting a reduction of GHGs produced by the facility using the sensor responsive to operating the GHG reduction system;
determining carbon credits earned for the reduction of GHGs produced by the facility using a carbon reduction calculation methodology, wherein the carbon reduction calculation method calculates a baseline emissions of the facility using the following equation:
$$B {E}_{y} = \sum \frac{E {D}_{i y} \times E {F}_{i f y} \times 100 \times {IR}_{i y}^{y - 1}}{A F E {C}_{i y} \times {MPG}_{i y}}$$
where BEy is the baseline emissions in a year y, EDi,y is the electricity delivered by a project charging systems serving applicable fleet i in project year y, EFj,f,y is the emission factor for the fossil fuel f used by comparable fleet vehicles j in project year y, IRi is the technology improvement rate factor for the applicable fleet i, AFECi,y is the weighted average electricity consumption per 100 miles rating for EVs in applicable fleet i in projection year y, and MPGi,y is the weighted average miles per gallon rating for the fossil fuel vehicles comparable to each EV in the applicable fleet i in the project year y; and
awarding an amount of cryptocurrency corresponding to the reduction of GHGs produced by the facility.
